(19) United States
(12) Patent Application Publication
(10) Pub. No.: US 2009/0022042 A1
(43) Pub. Date: Jan. 22, 2009

(54) E-WRITER HEAD

(76) Inventor: Ramesh Jagannathan, Rochester, NY (US)

Correspondence Address: J. Lanny Tucker, Patent Legal Staff;Eastman Kodak Company, 343 State Street, Rochester, NY, 14650-2201, US

(21) Appl. No.: 12/172,299

(22) Filed: Jul. 14, 2008

(30) Foreign Application Priority Data
Jul. 17, 2007 (GB) 0713835.73

(51) Int. Cl. G11B 9/00

(52) U.S. Cl. 369/126

(57) ABSTRACT

An integrated electromechanical disc drive system for creating nanoscale patterns comprises a spinning disc coated with a liquid or solid film and at least one flying integrated write head, said write head being attached to a pivoted swing arm and comprising a heating tip locally exerting heat when a current is driven through it; and at least one electrically conductive electrode tip which functions as an electrostatic atomic force tip capable of exerting an electric field between the tip and the disc.

### CROSS-REFERENCE TO RELATED APPLICATION

This application claims priority to Great Britain Patent Application 0713835.7 filed Jul. 17, 2007, the entire disclosure of which is hereby incorporated herein by reference.

### FIELD OF THE INVENTION

This invention relates to the process of the creation of nano scale patterns on a surface, in particular to an integrated system to create such patterns.

### BACKGROUND OF THE INVENTION

The present invention is generally related to the lithographic process used to produce integrated circuits and electronics and optoelectronic devices. More specifically the present invention is related to a process for the creation of nanoscale patterns in a thin film coating on a substrate.

In semiconductor fabrication of integrated circuits, one of the key processing steps involves creation of a pattern in a thin film coating on a substrate, which, during subsequent process steps, is ether replicated in the substrate or in another material which is added onto the substrate. The thin film is used to protect a part of the substrate during the subsequent replication steps and is usually referred to as photoresist.

In a standard lithograph process a resist coating is exposed with a beam of electrons, photons or ions, through a mask or by scanning selected areas of the resist coating with a focused beam. The chemical structure of the resist is altered by the beam exposure. The exposed or the unexposed areas of the resist are subsequently processed and removed in a developer bath to recreate the patterns or the obverse of the mask or the scanning. The pattern resolution is primarily limited by the beam wavelength.

There is a continuous pressing need in the electronics industry to create progressively smaller patterns and a great need to develop low cost technologies for mass producing large area, sub 50 nm features.

While several technologies are being developed to address these needs the problem remains primarily unsolved. Electron beam, X-ray, scanning probe and nano-imprint, soft lithographic techniques have been extensively worked on but they all suffer from significant problems. Electron beam lithography is the best technique so far from a technical point of view but is inconceivable from a cost view point. X-ray techniques have high throughput and have demonstrated 50 nm resolution but again are very expensive. Scanning probe techniques provide the resolution but are slow.

Nano imprint, soft lithographic technologies have made rapid strides in the recent past to demonstrate resolutions of less than 100 nm but suffer from serious technical challenges. Whilst they can demonstrate capability in small area footprints they fail to consistently generate patterns with a resolution of less than 100 nm over larger areas. The apparent difficulty is likely due to the novel flow properties experienced by materials in the sub 10 nm regime. Nano imprint technology is a contact printing technology and when sizes get smaller than about 50 nm it is not possible to precisely control the material flow under the mould.

Another competing technology is usually referred to as the directed self assembly of di-block copolymers. A key aspect of this technology is the term “directed self assembly”. The process generally involves coating the di-block polymers on a substrate under the influence of a directional force. The directional force can be as simple as a confinement space whose dimensions are comparable to the dimensions of the desired nanoscale patterns, or an electric or magnetic field. It could be an electrostatic field manifest as hydrophobic or hydrophilic features on the substrate.

By directing the self assembly of the elements and by biasing the arrangement of the arrays on a surface, unprecedented aerial densities of nano scale features can be achieved. It is generally known in the field that when block copolymers (e.g. polystyrene-b-poly (ethylene oxide)) are coated onto a substrate containing trenches (for example, two micron in width and created by photolithography) within each trench arrays of ordered, nanosocopic domains are formed under appropriate processing conditions where each array is in orientation registry with the arrays in adjoining trenches. Most importantly is the fact that the block copolymer, by controlling the preparation conditions, self assembled into the structure with no external manipulation of the morphology.

Nealey and coworkers at the University of Wisconsin (Kim, S. O.; Solak, H. H.; Stoykovich, M. P.; Ferrier, N. J.; de Pablo, J. J.; Nealey, P. F.; Nature, 2003, 424, 411), took an alternate approach in controlling the lateral placement of these nanoscopic domains. They coated block copolymer of polystyrene-b-poly (methyl methacrylate) onto a surface that was patterned using soft x-rays. The surface patterning was done on a size scale commensurate with the size of the copolymer domains and each domain was directed on the surface. Without patterning, the lamellar domains (in this case) were randomly oriented on the surface. With patterning a precise distribution of the domains across the surface was achieved.

While the di-block technology is promising from the point of view of getting pattern sizes down 1 nm, there are problems with this technology. For example, the substrate on which the directed self-assembly is supposed to occur must be pre-treated to enable long term ordering. One of the ways this is done is to create nanoscale grooves using e-beam lithography, which is very expensive and time consuming. Also, this technology may not be suitable to multilayer stacks where masks have to be created on top of other layers which may not tolerate pre-treatment of any kind to enable directed self-assembly.

### SUMMARY OF THE INVENTION

Embodiments of the invention aim to address the problems outlined above and to provide a solution to the need for a low cost, high speed, non-contact, large area nano patterning technology. In particular, according to embodiments of the present invention there is provided an integrated electromechanical disc drive system to create nanoscale patterns, comprising a spinning disc coated with a liquid or solid film and at least one flying integrated write head, said write head being attached to a pivoted swing arm and comprising a heating tip locally exerting heat when a current is driven through it; and at least one electrically conductive electrode tip which functions as an electrostatic atomic force tip capable of exerting an electric field between the tip and the disc. An advantage of such embodiments is that they allow low cost and high speed non contact writing of sub 100 nm features in several shapes, which is not believed to be currently available. Large areas can be written in a short time. The various embodiments of the present invention also are reliable and robust.

### BRIEF DESCRIPTION OF THE DRAWINGS

The invention will now be described with reference to the accompanying drawings in which:

FIG. 1 is a schematic view of the system according to an embodiment of the invention;

FIG. 2 is a schematic view of the disc according to an embodiment of the present invention; and

FIG. 3 is a view of a further embodiment.

### DETAILED DESCRIPTION OF THE INVENTION

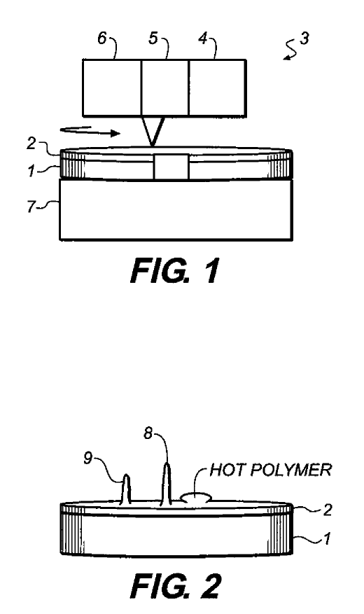

FIG. 1 is a schematic view of the system according to an embodiment of the present invention. The system comprises a disc 1 provided with a thin coating of a liquid or solid film 2 that may have a thickness of at least 5 nm. This film may comprise a polymer. However it will be understood by those skilled in the art that any suitable material may be used, such as a di-block copolymer, a tri-block copolymer, a polymer co-mixed with metal, semi-conductor, or insulating nanoparticles, blends of several polymers, or a monomer that is a liquid with a cross-linking agent. The disc is rotated by a motor 7. A write head 3 is located above the disc 1. In the embodiment illustrated, the write head 3 comprises a heating device 4, an electrode tip 5 and a cooling tip 6. However the cooling tip is not an essential feature of the write head. The write head is located a distance of nanometres above the disc. The write head is mounted on a swing arm (not shown). The write head is designed such that the heating device precedes the electrode tip, followed by the cooling tip. The heating device may be, for example, a resistive or laser heater. According to an embodiment, the electrode tip 5 may be coated with or attached to reservoirs of functional materials.

The spring constant of the swing arm and the rpm of the disc 1 are chosen such that the flying height of the head 3 above the film 2 is in the range of 5-100 nm. According to an embodiment, the dimensions of the disc are such that the longest, horizontal dimension is less than 1.5 m, the smallest horizontal dimension is greater than 0.05 m, and the smallest thickness dimension is greater than 0.001 m. According to an embodiment, a height between a top surface of the film and the lowest surface of the integrated write head is at least 1 nm and not greater than 1000 nm.

A portion of the film 2, which may be polymer, is heated above its glass transition temperature to a predetermined viscosity by the heating device 4 on the flying write head 3. The electrode tip 5 subsequently passes over the heated polymer coating. This causes a very high frequency electric field to be applied across the gap in a reliable and uniform way at low voltages. For example, 1 volt across a gap of 100 nm would create a field strength of 10 million volts/meter. The electric field across the gap causes electro hydrodynamic instability to occur. Thin film electro hydrodynamic instability phenomenon involves the creation of nanoscale replicate patterns of a master electrode pattern, on a polymeric thin film surface due to a phenomenon called electro hydrodynamic instability. This is described in E. Schaffer, T. Thurn-Albrecht, T. P. Russell and U. Steiner, Nature, 403, 874 (2000), R. V. Craster and O. K. Matar, Physics of Fluids, 17, 032104 (2005), N. E. Voicu, S. Harkema and U. Steiner (2006). This instability leads to the rise of a nodule 8 under the tip. This is illustrated in FIG. 2.

The cooling tip 6 then passes over the coating. The passing of the cooling tip over the hot nodule 8 results in a decrease of the temperature of the nodule to below its glass transition temperature. This freezes the nodule structure and prevents it from relaxing back to its original state. This process can be repeated several times over the circular track, leading to the creation of the desired nanoscale features along the circle.

The invention alternately provides a film containing a chemical that is chemically altered by exposure to light of a specific frequency, e.g. UV light. The cooling tip in this case is replaced by the light source. The chemical alteration can induce cross linking of the molecules of the film to create a solid state of matter, i.e. a nodule.

This invention, in principle, is eminently scalable in a linear fashion. That is, it could be envisioned that several thousands of such write heads could be mounted on several swing arms flying over large areas of the film, which need to be patterned. The write heads can also be directed to move to specific sectors of the film which need patterning by radially re-positioning the swing arms on the fly. The heights of the nodules can also be tuned to be location specific by adjusting both the electric field intensity and the number of exposures of the area to the field.

Numerous different embodiments may be envisioned.

### EXAMPLE 1

This example involves the use of an aluminum disc, having a diameter of 12.5 cm and with a central hole 1 cm in diameter. The central hole enables the disc to be mounted firmly onto a base motor. The motor can spin the disc at various revolutions per minute, ranging from 100 to 10,000. The aluminum disc has been previously spin coated with a polymer. The write head as described above is attached to the end of a swing arm whose base is pivoted at one side of the base mount. The swing arm is designed such that the write head sits gently on the polymer film at one corner of the aluminum disc referred to as the “landing zone.” Spinning of the aluminum disc results in aerodynamic lifting of the write head and the lift height can be tuned according to the principles governing the design of magnetic disc drives. The electro-mechanics of the swing arm are designed such that the write head can be moved and positioned at any specific location over the spinning disc. For example, we can envision moving the write head and positioning it at a position 2.5 cm radially from the centre of the disc. The flying height of the head is designed to be 100 nm at 6000 rpm. As the disc spins, an area of 100 nm of the polymer would experience an exposure time of 16 nano second under any point on the write head.

A situation can be envisioned where the heater raises the polymer temperature to above its glass transition temperature and the cooling system is capable of lowering the polymer temperature to below its glass transition temperature during the time of exposure. A steady voltage of 0.2 DC volts is applied across the gap resulting in field strength of 20 KV/cm, sufficient to create electro hydrodynamic instability of the film and growth of a polymer nodule. This three step process of heating, pulling and cooling results in a circular, polymer nodule growth on the coated thin film. The process is repeated several times at the same location until the height of the nodule is sufficient for the desired application.

### EXAMPLE 2

The example is very similar to that described in Example 1 except for the following. There are several write head systems on the swing arm, situated along its length. This results in the simultaneous generation of several circular nano nodules across the coated film. The applied voltage on any write head can be different and for the same number of exposures, this will enable us to tune the height of the nodules.

### EXAMPLE 3

The example is very similar to that described in Example 1 except for the following. The applied electric field is pulsed and the frequency of the pulse determines the location of the nano nodules along the circle.

### EXAMPLE 4

The example is similar to that described in Example 1 except for the following. The intensity of the pulse can be varied as the head travels the circumference of the disc. This results in different heights of nano nodules (reference numeral 9 in FIG. 2, for example) along the circumference, the height of the nodule having a one to one correspondence with the field strength.

### EXAMPLE 5

The example is similar to that described in Example 2 except for the following. The applied electric field is pulsed and the pulse frequency and intensity can be varied to influence the location and height of nano nodules at these locations.

### EXAMPLE 6

The example is similar to that described in Example 1 except for the following. There are several write heads situated across the arc of the swing arm. This will result in multiple exposures of the nodules to the electric field during a revolution, leading to enhanced growth.

### EXAMPLE 7

The example is similar to that described in Example 6 except for the following. The applied electric field is pulsed and the frequency and intensity of the field will influence the location and rate of growth of the nodules per rotation.

### EXAMPLE 8

The example is similar to that described in Example 2 except for the following. There are multiple swing arms per spinning disc. This will significantly improve the capability to create nano nodules over large areas of the coated film per rotation. The applied field can be steady or pulsed. In the case of pulsed fields, the intensity of the pulses can vary from head to head.

### EXAMPLE 9

The example is similar to the description in Example 1 except for the following. The spinning aluminum disc is coated with film of a monomer and a cross linking agent which can initiate polymerization when exposed to UV light. The write head will now include a UV light source as well which can be housed adjacent to the cooling system.

### EXAMPLE 10

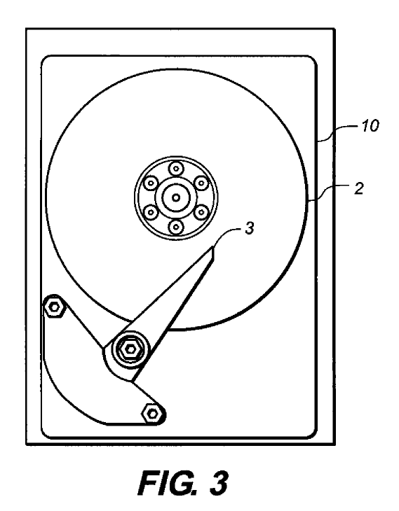

The example is similar to the description in Example 1 except that the write head contains only the electrode tip and the heating device. The entire system, including the spinning disc, motor and the flying head are encased in a refrigerated, cold box 10 as shown in FIG. 3. In this example, the polymer is locally heated above the glass transition temperature and e-pulled and as the nodule leaves the vicinity of the electrode tip, it is cooled by the atmosphere in the refrigerated box and frozen in place.

### EXAMPLE 11

The example is similar to the description in Example 10 except for the following. The box is filled with a liquid and the disc now spins in the liquid medium. This would enable the use of higher electric fields than possible in air due to higher breakdown voltages. Also, the viscosity of the liquid can be adjusted to tune the flying height besides the physical properties of the swing (cantilever) arm alone.

### EXAMPLE 12

The example is similar to Example 1 except for the following. The head is an erase head rather than a write head and only consists of a heating device. The temperature of the erase head is above the glass transition temperature of the polymer and thereby will erase all the polymer nodules. There can be a multiplicity of erase heads per spinning disc.

The invention has been described in detail with reference to preferred embodiments thereof. It will be understood by those skilled in the art that variations and modifications can be effected within the scope of the invention.

The invention can be used whenever it is required to create nano scale patterns on a surface.

### PARTS LIST

1 disc
2 thin coating of a liquid or solid film
3 write head
4 heating device
5 electrode tip
6 cooling tip
7 motor
8 nodule
9 nodule with different height
10 cold box

1. An integrated electromechanical disc drive system to create nanoscale patterns, comprising a disc coated with a liquid or a solid film and at least one flying integrated write head, said write head being attached to a pivoted swing arm and comprising:
a. a heating device locally exerting heat when a current is driven through it; and
b. at least one electrically conductive electrode tip which functions as an electrostatic atomic force tip capable of exerting an electric field between the heating tip and the disc.

2. The drive system as claimed in claim 1, wherein the write head further comprises a cooling tip that can be cooled, thereby locally removing heat.

3. The drive system as claimed in claim 1, wherein the write head further comprises a micro nozzle through which a jet of cold gas can be purged in a continuous or pulsed fashion.

4. The drive system as claimed in claim 1, further comprising a UV light source.

5. The drive system as claimed in claim 1, enclosed in a refrigerator box to keep the system below a glass transition temperature of the liquid or the solid film.

6. The drive system as claimed in claim 1, wherein the liquid or the solid film is polymeric and contains chemical species capable of absorbing photons of at least one wavelength.

7. The drive system as claimed in claim 1, wherein the liquid or the solid film is a polymeric film containing nanoparticles.

8. The system as claimed in claim 1, wherein the heating device is a resistive heater.

9. The system as claimed in claim 1, wherein the heating device is a laser heater.

10. The system according to claim 1, wherein dimensions of the disc are such that the longest, horizontal dimension is less than 1.5 m, the smallest horizontal dimension is greater than 0.05 m and the smallest thickness dimension is greater than 0.001 m.

11. The system according to claim 1, wherein the height between a top surface of the liquid or the solid film and a lowest surface of the integrated write head is at least 1 nm and not greater than 1000 nm.

12. The system according to claim 1, wherein the liquid or the solid film can be a liquid polymer.

13. The system according to claim 1, wherein the thickness of the liquid or the solid film is at least 5 nm.

14. The system according to claim 1, wherein the liquid or the solid film is a di-block copolymer, a tri-block copolymer, a polymer co-mixed with metal nanoparticles, a polymer co-mixed with semi-conductor nanoparticles, a polymer co-mixed with insulating nanoparticles, a polymer co-mixed with any combination of metal, semi-conducting, or insulating nanoparticles, a blend of several polymers, or a monomer that is a liquid with a cross-linking agent.

15. The system according to claim 1, wherein there are more than one pivoted swing arms.

16. The system according to claim 1, wherein there is more than one write head per pivoted swing arm.

17. The system according to claim 1, wherein at least one of the electrically conductive electrode tips is coated with functional materials.

18. The system according to claim 1, wherein at least one of the electrically conductive electrode tips is attached to reservoirs of functional materials.

19. A method of operating the system claimed in claim 1, wherein a constant amount of heating is applied to the film such that the film is above its glass transition temperature.

20. The method according to claim 19, wherein the film is subjected to a high frequency electrostatic field so that the field strength and time of exposure to the field is sufficient to cause the film to undergo electro hydrodynamic instability, leading to finite growth of the film under the electrode tip where the field is applied to result in the creation of a nodule.

21. The method according to claim 20, wherein the film is subjected to a constant amount of cooling sufficient enough to cool the film to below its glass transition temperature so as to freeze the nodule and thereby significantly reduce its rate of relaxation.

22. The method according to claim 20, wherein the nodules are created along a circle under the write head, the frequency of which is determined by the frequency of the applied electric field.

23. The method according to claim 20, wherein the nodule is again subjected to a high frequency electrostatic field leading to significant growth of the nodules.

24. The method according to claim 20, wherein there are several write heads per pivoted swing arm and each write head creates nodules.

25. The method according to claim 20, wherein the write heads are instructed, as a group, to move to a specific vector position to create nodules.

26. The method according to claim 20, wherein the creation of nodules exposes a clean substrate adjacent to them creating an in situ mask of the polymer over the substrate.

27. The drive system as claimed in claim 1, wherein there is a metal layer beneath the liquid or the solid film.

28. The drive system as claimed in claim 1, wherein the write head is replaced by an erase head, the erase head comprising a heating tip locally exerting heat when a current is driven through it.
